(19) United States
(12) Patent Application Publication
(10) Pub. No.: US 2025/0258658 A1
(43) Pub. Date: Aug. 14, 2025

(54) SYSTEMS AND METHODS FOR CREATING SOFTWARE USING JOURNEYS/FEATURES AND SWIMLANES

(71) Applicant: Engineer.ai Global Limited, London (GB)

(72) Inventors: Sachin Dev Duggal, London (GB); Rohan Patel, London (GB)

(21) Appl. No.: 19/054,452

(22) Filed: Feb. 14, 2025

Related U.S. Application Data
(60) Provisional application No. 63/558,531, filed on Feb. 27, 2024.
(60) Provisional application No. 63/553,545, filed on Feb. 14, 2024.

(51) Int. Cl. G06F 8/34; G06Q 10/10

(52) U.S. Cl. CPC G06F 8/34; G06Q 10/103

(57) ABSTRACT

An online software development system helps users create custom software by selecting a base application and defining journeys and their associated features. The system manages these features across parallel swimlanes, automatically recalculating timelines, costs, and resource usage in real time whenever journeys or features are added or removed. Each swimlane holds a maximum threshold of features, ensuring balanced workloads and efficient delivery. Machine learning algorithms can further optimize swimlane distribution, improving development speed and resource utilization. Through an interactive user interface, the system generates a build card that displays the latest project details, facilitating clearer project management and faster software development.

### CROSS-REFERENCE TO RELATED APPLICATIONS

This application claims priority under 35 U.S.C. § 119 (e) to U.S. Provisional Patent Application No. 63/553,545, filed on Feb. 14, 2024, the entire contents of which is hereby incorporated by reference in its entirety.

### TECHNICAL FIELD

Embodiments of the present disclosure related to the field of software development. Specifically, embodiments of the present disclosure are related to systems and methods for the project management of developing software involving using journeys and features; and using swimlanes that can determine a timeline to complete the custom software.

### BRIEF DESCRIPTION OF THE FIGURES

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 describes and illustrates a user experience in choosing a base application with journeys and features, using a screenshot from a user interface of an example embodiment of the present disclosure for creating software;

FIGS. 2 and 3 describe and illustrate a user experience in naming a custom software application or choosing a color and updating a logo for the application, using a screenshot from a user interface of an example embodiment of the present disclosure for creating software;

FIG. 4 describes and illustrates a user experience in exploring journeys included in the custom software application based on the selected base application and suggested journeys, using a screenshot from a user interface of an example embodiment of the present disclosure for creating software;

FIG. 5 describes and illustrates a user experience in exploring features that fall under the included journeys, using a screenshot from a user interface of an example embodiment of the present disclosure for creating software;

FIG. 6 describes and illustrates a user experience in exploring features in a card format that fall under a specific journey among the included journeys, using a screenshot from a user interface of an example embodiment of the present disclosure for creating software;

FIG. 7 describes and illustrates a user experience in hovering the features of FIG. 6 to review detailed description, using a screenshot from a user interface of an example embodiment of the present disclosure for creating software;

FIG. 8 describes and illustrates a user experience in clicking the features of FIG. 6 to review further detailed description, using a screenshot from a user interface of an example embodiment of the present disclosure for creating software;

FIG. 9 describes and illustrates a user experience in adding a suggested journey to the included journeys, using a screenshot from a user interface of an example embodiment of the present disclosure for creating software;

FIG. 10 describes and illustrates a user experience in exploring more journeys to be added to the included journeys, using a screenshot from a user interface of an example embodiment of the present disclosure for creating software;

FIGS. 11-12 describe and illustrate a user experience in exploring a prototype with the selected features, using a screenshot from a user interface of an example embodiment of the present disclosure for creating software;

FIG. 13 describes and illustrates a user experience in exploring the selected features in a flow mode, using a screenshot from a user interface of an example embodiment of the present disclosure for creating software; and

FIGS. 14-16 describe and illustrate a user experience in in reviewing and choosing details of the custom software application, using a screenshot from a user interface of an example embodiment of the present disclosure for creating software.

FIG. 17 depicts an exemplary networked environment for implementing an online software development platform, including multiple client devices, one or more servers, and a communication network.

FIG. 18 is an exemplary illustration of a computing device (e.g., a mobile phone, tablet, or desktop) usable as a client device in certain embodiments.

FIG. 19 depicts an embodiment of a builder application architecture, showing databases for features and design specifications, which the platform consults when generating build cards and distributing tasks among developers.

FIG. 20 is a flowchart illustrating a user-driven configuration process for creating a custom software application, from the initial platform access to final build card generation.

FIG. 21 is a flowchart illustrating a swimlane-adjustment process for organizing features into parallel workstreams and dynamically updating the development timeline in response to user changes.

These and other embodiments are detailed below with reference to the above-referenced figures.

### SUMMARY

Embodiments of the present disclosure relate to an online software development system that utilizes “journeys” to group related application features and “swimlanes” to manage development in parallel workstreams. By dynamically adjusting these swimlanes upon user selection or removal of features, the system provides real-time updates to projected timelines and costs, enhancing resource management and development efficiency.

In some embodiments, an online software development system for creating software applications includes a computer configured to determine one or more user journeys for a user's custom software application based on a selection of a base application or other user inputs, determine a set of swimlanes as parallel workstreams for defining a development timeline based on the journeys and features, enable the user to modify at least one of the journeys or features, adjust the set of swimlanes in response to that modification, and display to the user in real time either updated pricing information or an updated development timeline based on the journeys and features.

In these embodiments, the system may maintain a threshold minimum and maximum number of features allowable in each swimlane and may automatically split a journey into multiple swimlanes if adding a new feature would exceed that threshold; it may remove or merge swimlanes when the removal of at least one feature reduces a swimlane's feature count below the minimum threshold, then recalculate the development timeline; it may apply one or more machine learning algorithms to distribute features among swimlanes so as to minimize total completion time; and it may generate a build card comprising the journeys, swimlanes, pricing details, and the development timeline, displaying the build card to the user and enabling further real-time edits.

Furthermore, the computer may be further configured to automatically categorize each feature as either essential or recommended, and to prompt the user with a requirement to delete or alter a journey when the user attempts to remove an essential feature. The computer may be further configured to provide a user interface that enables the user to select at least one operating system or platform for building the custom software application, and to update the development timeline or pricing based on the selected operating system(s) or platform(s). The computer may be further configured to accept real-time feedback or annotations from the user on any journey or feature, and to recalculate any associated cost or duration based on the user's feedback. The computer may be further configured to access a code repository storing source code for previously used features, automatically retrieve and assemble the appropriate modules for the user's selections and indicate any newly created or updated source code segments needed to complete the build. The computer may be further configured to estimate resource allocation for balancing feature development across swimlanes and minimizing the total cost of completing the custom software application.

### DETAILED DESCRIPTION

The following description of various exemplary embodiments is provided to enable those skilled in the art to make and use the subject matter described herein. These embodiments are merely illustrative and are not meant to limit the scope of the subject matter claimed. It will be understood that various modifications, substitutions, and variations can be made without departing from the spirit or scope of the appended claims.

As used herein, the singular forms “a,” “an,” and “the” are intended to include the plural forms as well, unless the context clearly indicates otherwise. Likewise, the term “or” is intended to cover “and/or,” and “comprises” or “including” is intended to cover “consisting essentially of” and “consisting of,” where appropriate.

References to specific examples, embodiments, or implementations are for illustrative purposes only and do not limit the scope of the disclosure. Features of any one embodiment or example can be combined with features of any other embodiment or example, unless stated otherwise. Thus, different arrangements of the disclosed features are all within the scope of the present disclosure.

Any discussion of potential advantages is not intended to be limiting, as other embodiments may provide the same or different advantages. The scope of the disclosure, and any claims that may issue, is to be determined solely in view of the entirety of the present disclosure, including the drawings, and the applicable legal standards.

Where the specification refers to “some embodiments,” “an embodiment,” or similar language, it should be understood that these phrases mean that at least one implementation falls within the description. Likewise, the same reference numerals in different figures refer to the same or similar elements.

The term “base application” used herein refers to an initial or template software application that includes a default set of journeys and features. This serves as a starting point for creating a custom software application that shares functionalities or design elements with the chosen template.

The term “features” used herein refers to discrete units of functionality within a custom software application. Each feature typically includes one or more functions, user interfaces, or data-processing capabilities that together provide a particular outcome or service.

The term “journeys” used herein refers to user flows within a custom software application that group together related features sharing a common function or purpose. By organizing features according to similarities or connections, journeys enable an end user to visualize and validate the software's step-by-step experience, as well as easily add or remove features during the design process.

The term “swimlanes” used herein refers to parallel workstreams in a project management environment that streamline software development by grouping features based on their interdependencies or complexity.

The term “threshold number” used herein refers to a maximum capacity or limit of features that can be grouped within a single swimlane.

The term “Minimum Viable Product” or “MVP” used herein refers to an initial version of a custom software application containing only essential features. The MVP is generally built early to validate core functionality and gather user feedback.

The term “flow mode” used herein refers to a visual or graphical representation of how selected features connect or transition within the custom software application, enabling users to review end-to-end user experiences and feature relationships.

The term “build card” used herein refers to a consolidated project overview for developing a custom software application.

The term “Statement of Work” or “SOW” used herein refers to a document or specification outlining key details of a project.

The term “project manager” used herein refers to either an individual or a system component that oversees development tasks, manages swimlanes, coordinates resources, and ensures timely completion of the custom software application.

The term “prototype” used herein refers to an interactive or visual mock-up of a custom software application.

The term “machine learning model” or “model” used herein refers to a set of algorithmic routines and parameters configured to predict one or more outputs of a real-world process (for example, the trajectory of an object or a user's content preference) based on a set of inputs, without being explicitly programmed. A model's structure (e.g., the number and arrangement of subroutines) and/or its parameter values are determined through a training process that utilizes real-world or simulated data. Such models cannot exist or function without computing technology, and they differ from traditional statistical analyses by virtue of learning automatically from data rather than following explicitly programmed instructions.

The term “large language model” or “LLM” used herein refers to a specialized type of machine learning model designed for natural language processing tasks, such as text generation or language understanding. LLMs by definition have a large number of parameters, and are typically trained in a self-supervised manner on extensive text corpora, enabling them to perform advanced linguistic tasks like contextual understanding or content generation.

The term “training” of a machine learning model used herein refers to the process of building and/or updating a model by using one or more sample datasets. A “training set” is used to iteratively adjust the model's parameters, and additional sample datasets, such as a “validation set” or a “test set,” may be used to evaluate and benchmark the model's performance. Once trained, the model may be deployed in a production environment to make predictions, generate content, or perform other decision-making tasks based on new input data. This training is performed (e.g., only) before the LLM is used or incorporated into the illustrative systems (ad described) or otherwise in the system. It may involve additional training such as when the LLM is an internal resource in the same domain as the software development platform.

Embodiments of the present disclosure solve technical problems in conventional software development platforms by automatically adjusting the grouping and sequencing of tasks in real time based on user selections of journeys and features. Traditional methods often rely on manual or ad hoc recalculations whenever new requirements arise, leading to inefficiency and human error. By contrast, the disclosed system dynamically reconfigures swimlanes, continuously updating scheduling, pricing, and resource usage without interrupting the workflow. This addresses the technical challenge of effectively managing and reallocating computing resources (e.g., servers, databases, version-control systems) in a constantly evolving development environment.

Furthermore, maintaining a threshold number of features per swimlane and, in some embodiments, applying machine learning for optimal workload distribution reduces processing overhead and network traffic. By minimizing repeated communications and preventing any single workstream from overloading, the system enhances the efficiency of the computing platform. Fewer recalculations, data transmissions, and database updates are required when features are added or removed, providing improvements to how a computer-based software development system processes, distributes, and tracks features.

Accordingly, these methods improve computing resource utilization, development speed, real-time metric updates, and error reduction. Unlike traditional project management tools, the disclosed system dynamically adjusts to changing requirements, representing a technological advancement in the field of software development platforms. By leveraging unique data structures (e.g., swimlanes and journeys) and algorithms, the system can automatically reorganize tasks in response to user input.

Embodiments of the present disclosure disclose a system and method that automate aspects of developing software applications. Specifically, embodiments of the present disclosure provide a process as part of a customer driven application development platform. A computer-implemented process can be implemented that provides a platform that is accessible by a customer using, for example, conventional browsers. The platform can operate as a cloud-based service that permits the user to interact with the platform through graphical user interfaces to complete the different stages of the application development process. Generally, this involves a combination of one or more computers, software implemented on one or more computers that configures the computers to provide a specialized application, and an online environment, such as the Internet, through which users can access to the functionality using a web browser or a dedicated software application (e.g., a mobile app).

Embodiments of the present disclosure provide for systems and methods for a user to design a custom software application that for example can be based on a base application including journeys comprising base features. Journeys allow customers to define multiple user flows within the custom software application, seamlessly integrated into the build card. Each journey intelligently organizes interactive workflows tied to feature development. A user can add additional journeys/features or subtract undesired journeys/features, which may dynamically change total duration and cost of completing the custom software application.

In some embodiments, the system leverages a trained machine learning model—such as a large language model (LLM) or another specialized model—to optimize feature distribution and resource allocation across swimlanes. For instance, the model can be trained on historical data that captures project timelines, cost outcomes, and user selections, enabling it to predict how newly added journeys or features might affect overall development time or expense. During operation, the trained model analyzes incoming data (e.g., a user's chosen combination of journeys, platform requirements, or project constraints) and provides real-time recommendations on how to assign tasks to each swimlane for balanced workload and minimized cost. By incorporating this model into the broader system architecture, the platform continuously improves how it adjusts swimlane configurations, ultimately reducing user intervention and enhancing development efficiency.

The system can be configured to use the detected features to generate a product specification or statement of work.

During an initial process stage, a user can use the platform to specify requirements for the desired software application, and may also provide interactive feedback or refine the design through the platform's user interface. This can include visual design inputs and iterative feedback on proposed requirements.

In some preferred embodiments, the platform is an online software development platform that is used by the public to engage a company to develop a particular software application for the customer. An example of such a system is illustratively described in U.S. Patent Publication No. 20180107459, by Duggal et al., filed Oct. 17, 2017, which is incorporated herein by reference in its entirety. The platform is preferably configured to provide the user, a potential customer, with the ability to interact with different interactive user interfaces to intuitively specify the requirements for the desired custom software application. The platform can be configured to operate as an application in object code that interacts with the user. The platform preferably includes a repository of existing source code for individual features that have been previously collected, used and/or tested to implement a corresponding feature. This source code can be reused, modified or compiled during the software development to produce the user's final software application.

The platform can also include a subsystem that communicates with a set of third party software developers to communicate the requirements, for example, via messaging, and to engage the developers to develop additional source code or desired modification that after a query to the existing database of feature source code is determined to be needed or unavailable in the repository, thus requiring the developers to create new code for requirements or selections that are not in the repository (which is communicated via the platform). The platform can also communicate the requirements internally via electrical communications and in response automatically generate or assemble source code that contains the source code for the selected features from the repository. The repository can store different versions of the source code, such as for different operating systems or different end user platforms (e.g., mobile phones or desktops). As part of the software development process, the platform can display interfaces that require the user to select the operating system and end user platform. The platform takes that selection into account in pricing and/or generating or assembling source code for a customer's actual application.

The platform can be configured to allow the user to select automatic detection as a preliminary step in order to specify the requirements for the desired custom software application. In some embodiments, the platform can be configured to allow the user to select features (using a user interface). In response to the feature detection/selection, the platform can use that information to automatically generate pricing, taking into account selected features.

The platform can therefore be configured for the user to perform the design process or a portion thereof. The platform can preferably provide the user with an integrated resource for the process for software development where there is preexisting common structure between design and development.

Embodiments of the present disclosure provide for systems and methods for a project manager to coordinate the development of the custom software application designed by the user. The project manager platform comprises a workflow named swimlanes, correlated to journeys, which determines the development timeline to build the custom software application. Swimlanes can be understood to be parallel workstreams to expedite delivery by organizing features into groups according to their estimated interdependence, thereby enhancing efficiency. Similar to journeys, a configuration or arrangement of swimlanes may dynamically change based on the user's selection or deselection of journeys and features.

The duration required to complete the longest swimlane may essentially set the overall timeline for the build card.

Swimlanes may have a threshold (e.g., maximum) number (x) of features. If an added journey exceeds the threshold number, it can be split into two swimlanes so that each lane contains fewer than the threshold number of features. Each new lane would still correspond to the same journey, allowing the system to automatically assign tasks to selected developers.

For example, three journeys—J1 with 14 features, J2 with 40 features, J3 with 26 features—may be mapped as follows:

| swimlane 1 | swimlane 2 | swimlane 3 |
|---|---|---|
| J1 | J2 | J3 |
| 14 features | 40 features | 30 features |

If, however, the threshold number (x) is 30, swimlane 2 in the above mapping will exceed the threshold number.

To meet the threshold, swimlane 2 may be divided into swimlane 2 and swimlane 3. The initial content of swimlane 3 may then be shifted to a new swimlane 4, resulting in the following arrangement:

| swimlane 1 | swimlane 2 | swimlane 3 | swimlane 4 |
|---|---|---|---|
| J1 | J2 | J2 | J3 |
| 14 features | 20 features | 20 features | 30 features |

If a user adds a feature that falls under J3, swimlane 5 may be added because swimlane 4 already contains the maximum number of features (30), resulting in the following exemplary swimlane mapping:

| swimlane 1 | swimlane 2 | swimlane 3 | swimlane 4 | swimlane 5 |
|---|---|---|---|---|
| J1 | J2 | J2 | J3 | J3 |
| 14 features | 20 features | 20 features | 30 features | 1 feature |

If a user subtracts a feature from the 30 features of J3 that fall under swimlane 4, the single feature under swimlane 5 may be moved to swimlane 4, and swimlane 5 may be removed), resulting in the following exemplary swimlane mapping:

| swimlane 1 | swimlane 2 | swimlane 3 | swimlane 4 |
|---|---|---|---|
| J1 | J2 | J2 | J3 |
| 14 features | 20 features | 20 features | 30 features |

A project manager may change the threshold number (x), for example, from 30 to 25, generating the following exemplary swimlane mapping:

| swimlane 1 | swimlane 2 | swimlane 3 | swimlane 4 | swimlane 5 |
|---|---|---|---|---|
| J1 | J2 | J2 | J3 | J3 |
| 14 features | 20 features | 20 features | 15 features | 15 features |

In some embodiments, some features require more development time than others. For example, swimlane 1 with 14 features may take longer to complete than swimlane 2 with 20 features, or vice versa. Similarly, swimlane 2 with 20 features may require more time than swimlane 3 with 20 features, or vice versa.

In some embodiments, a swimlane mapping may be generated in a way that minimizes the completion time of the longest swimlane using, for example, machine learning.

In other words, the mapping may minimize the total cost for building the custom software application, also using machine learning.

A user can add a new journey (e.g., J4) with a specific number (e.g., 18) of features, resulting in the following exemplary swimlane mapping:

| swimlane | swimlane | swimlane | swimlane | swimlane | swimlane |
|---|---|---|---|---|---|
| 1 | 2 | 3 | 4 | 5 | 6 |
| J1 | J2 | J2 | J3 | J3 | J4 |
| 14 | 20 | 20 | 15 | 15 | 18 |
| features | features | features | features | features | features |

A user can also subtract a base journey (e.g., J1), resulting in the following exemplary swimlane mapping:

| swimlane 1 | swimlane 2 | swimlane 3 | swimlane 4 | swimlane 5 |
|---|---|---|---|---|
| J2 | J2 | J3 | J3 | J4 |
| 20 features | 20 features | 15 features | 15 features | 18 features |

As a result, previous swimlane 1 is removed, and contents of previous swimlanes 2-6 shift to swimlanes 1-5.

In some embodiments, the journeys themselves may be renumbered, resulting in the following exemplary swimlane mapping:

| swimlane 1 | swimlane 2 | swimlane 3 | swimlane 4 | swimlane 5 |
|---|---|---|---|---|
| J1 | J1 | J2 | J2 | J3 |
| 20 features | 20 features | 15 features | 15 features | 18 features |

A user may also add or subtract individual features. For example, the user might add 1 feature under J1 and subtract 1 feature from J3), resulting in the following exemplary swimlane mapping:

| swimlane 1 | swimlane 2 | swimlane 3 | swimlane 4 | swimlane 5 |
|---|---|---|---|---|
| J1 | J1 | J2 | J2 | J3 |
| 21 features | 20 features | 15 features | 15 features | 17 features |

Each added or subtracted journey or feature affects the duration/cost, depending on which journeys or features were previously selected.

In some embodiments, a user can begin with 0 journeys and 0 features (e.g., no base application selected). If journeys or features are added later, the resulting swimlane mapping follows the above general principles.

For example, a user might add J1 with 15 features and J2 with 18 features (assuming the project manager sets x to 30), generating this mapping:

| swimlane 1 | swimlane 2 |
|---|---|
| J1 | J2 |
| 15 features | 18 features |

If the user makes further changes, the swimlane mapping is automatically updated to reflect any new additions or deletions, applying the same logic described above.

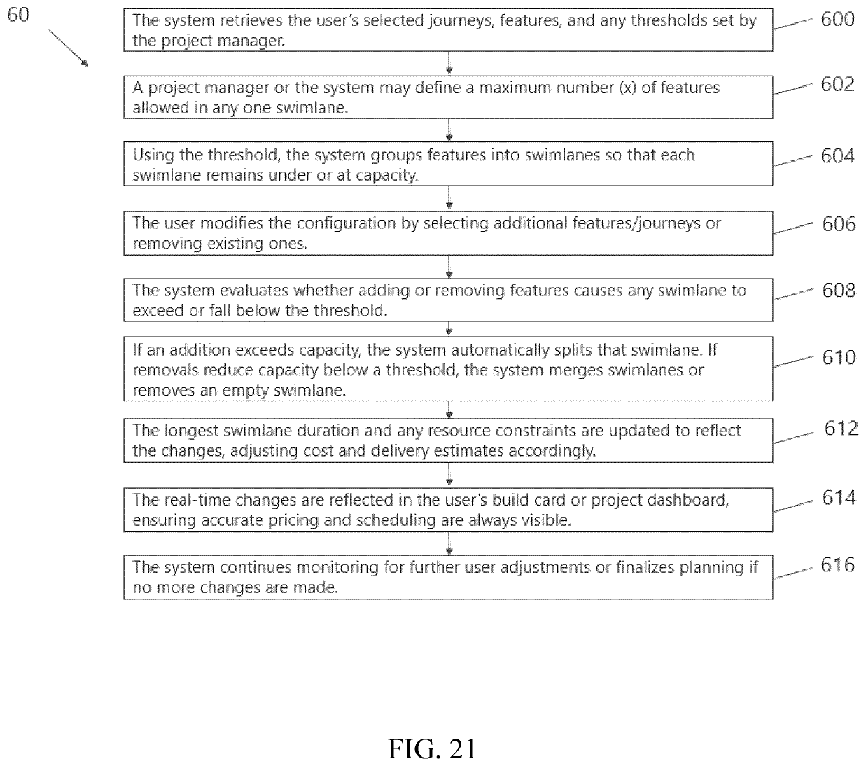

The above logic is generalized in FIG. 21, where a flowchart 60 illustrates how the system adjusts swimlanes in real time. In step 600, the system retrieves the user's selected journeys, features, and any threshold values. At step 602, a project manager or the system may define a maximum number (x) of features allowed in a swimlane. In step 604, the system groups feature into swimlanes according to that threshold, ensuring each swimlane remains under capacity.

At step 606, the user modifies the configuration by selecting additional features or journeys or removing existing ones. Next, in step 608, the system checks whether adding or removing features causes a swimlane to exceed or fall below the threshold. If the threshold is exceeded, the system automatically splits the swimlane (step 610); if capacity falls below a certain level, the system merges or removes a swimlane. In step 612, the system recalculates the overall project timeline and updates any relevant cost or resource allocations. Finally, at step 614, the updated details are reflected in the user's build card or project dashboard. If no more changes occur (step 616), the process may end or continue monitoring for further user inputs.

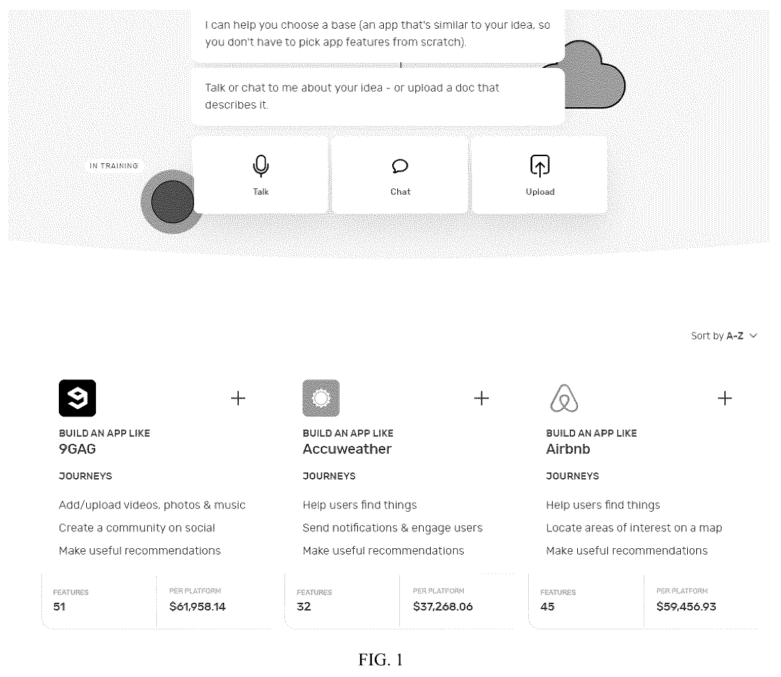

FIG. 1 describes and illustrates a user experience in choosing a base application with journeys and features, using a screenshot from a user interface of an example embodiment for creating software. The user interface may display multiple base applications that serve as potential starting points for a user's custom software application. A user can select at least one base application that resembles the envisioned custom software application. Each base application may show information thereof, including representative journeys/features, the number of features, and base pricing. In some embodiments, a user may talk or chat with their idea about a custom software application. As explained above, journeys correlate to swimlanes but incorporate an extra layer of customer validation, grouping features with similar functions or connections. Therefore, when journey information is available for a build card, it may override the swimlane mapping logic, making that logics inapplicable in such cases.

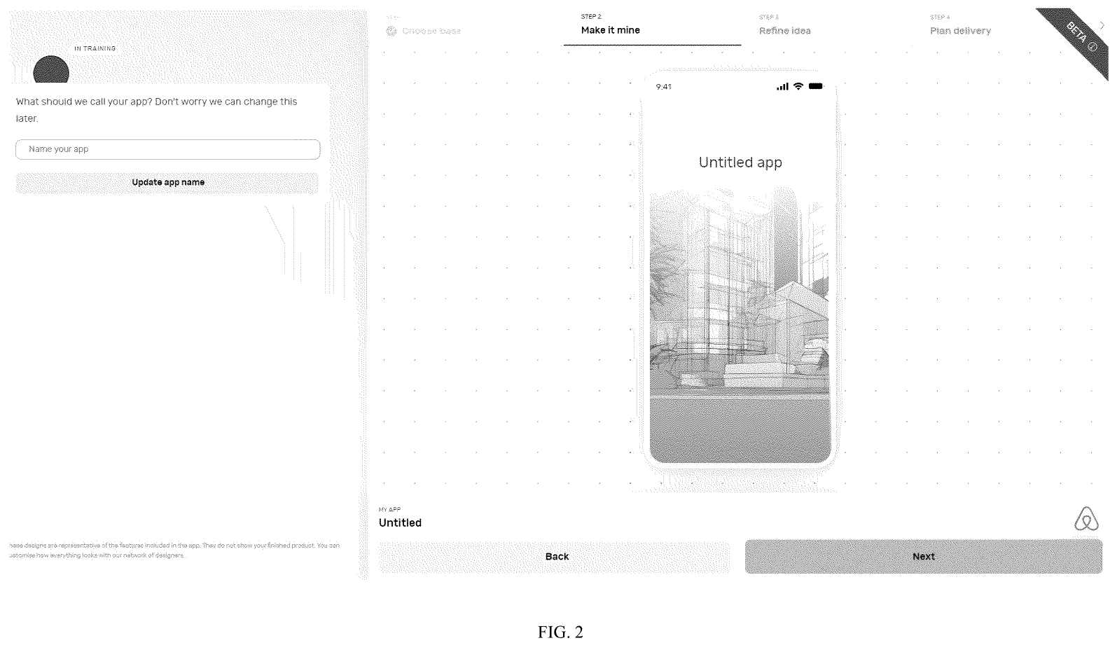

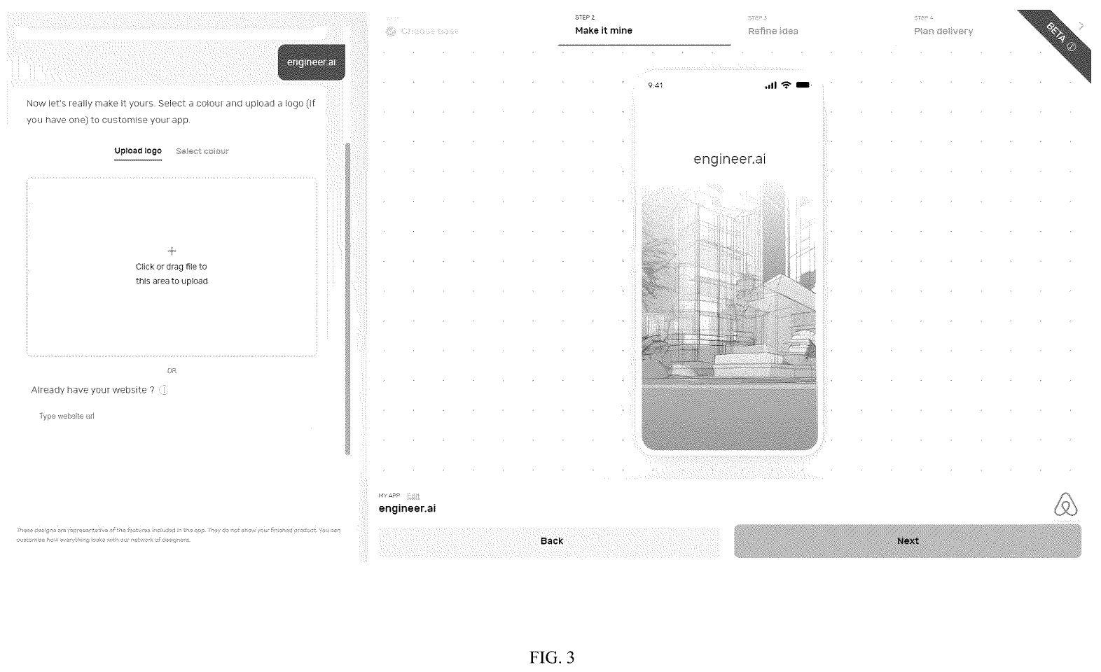

FIGS. 2 and 3 describe and illustrate a user experience in naming a custom software application or choosing a color and updating a logo for the application, using a screenshot from a user interface of an example embodiment for creating software.

In some embodiments, a user can change the name of the custom software application at any point. A user may also upload a logo or choose a color for the application. Alternatively, by providing a website address, a user may allow the system to extract a logo or color scheme from the website for the application.

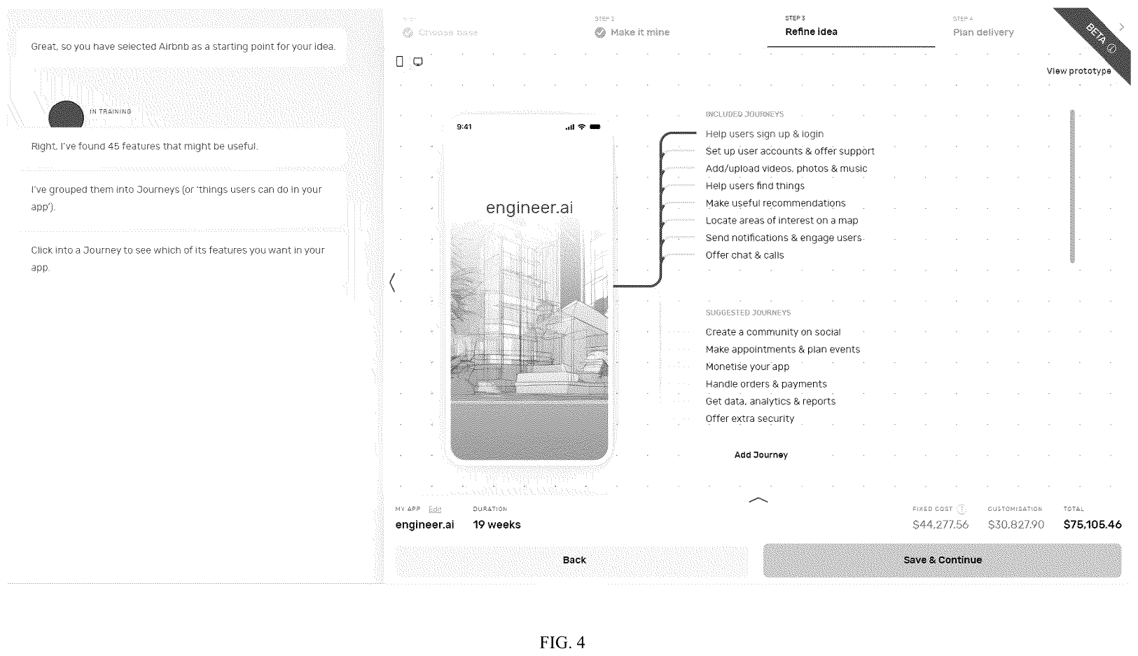

FIG. 4 describes and illustrates a user experience in exploring journeys included in the custom software application, based on the selected base application and suggested journeys, using a screenshot from a user interface of an example embodiment for creating software.

The screenshot may show INCLUDED JOURNEYS from the selected application (e.g., Airbnb). It may also show a list of SUGGESTED JOURNEYS, which may be ordered by relevance to the included journeys. It may also show the number of total features included in the custom software application. The features may be grouped into journeys titled with a common theme, function, purpose or topic of the features.

In some embodiments, when the user selects or searches for a base application, the system utilizes the large language model (LLM) to parse any textual or voice inputs describing the user's desired software.

The screenshot may also show the total duration, total cost, fixed cost, customization cost, which depends on the journeys/features included in the custom software application. Fixed cost, for example, may include access to the platform to track user's software application build, ongoing expert support, unlimited personalized prototypes, collaboration tools to manage user's project, updates, bug fixes and improvements-even after the user's software application is delivered.

The total duration may be determined by swimlane mapping described above. Total cost, fixed cost, and customization cost may also be influenced by swimlane mapping.

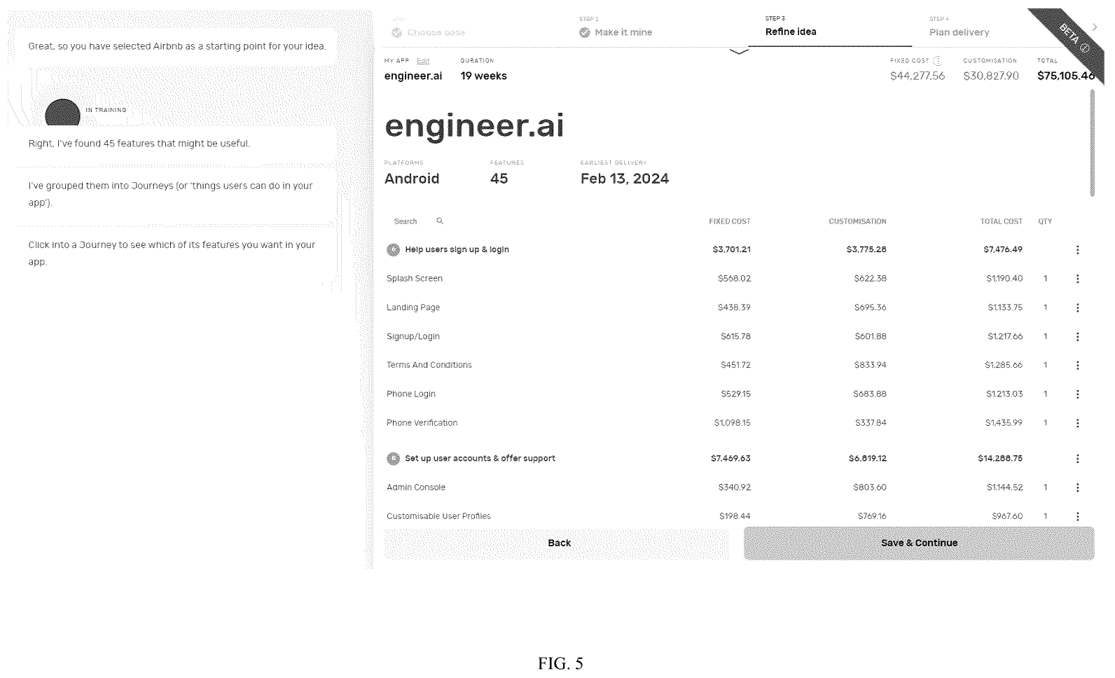

FIG. 5 describes and illustrates a user experience in exploring features that fall under the included journeys, using a screenshot from a user interface of an example embodiment for creating software. The user interface may provide individual costs for selected features and journeys, along with platform information, the number of features, and the earliest delivery date.

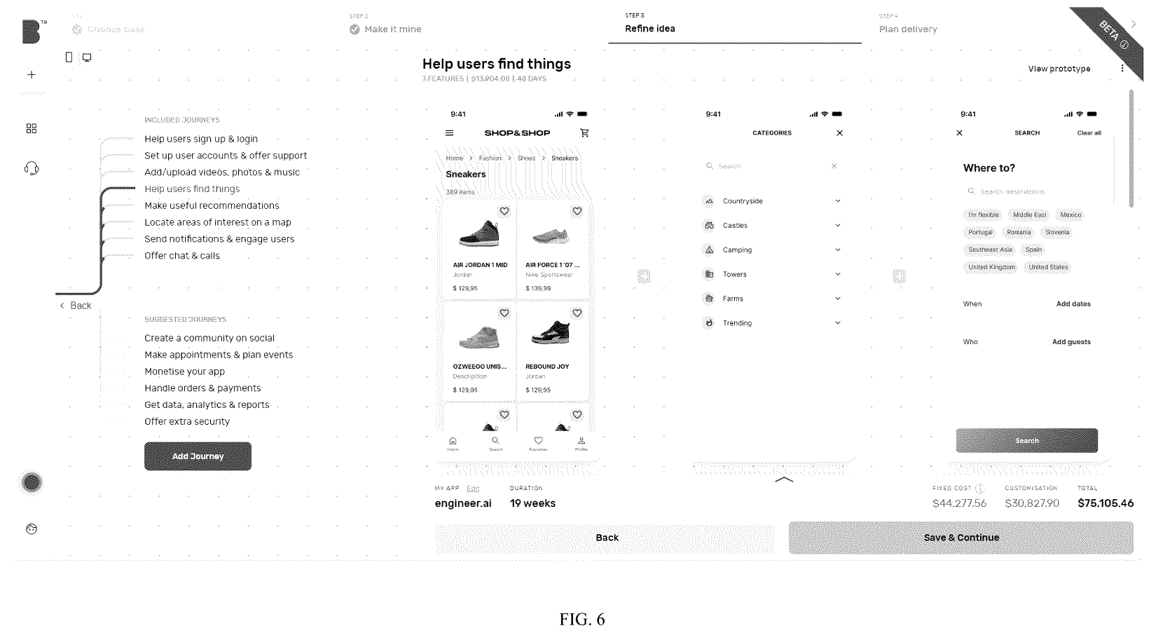

FIG. 6 describes and illustrates a user experience in exploring features in a card format that fall under a specific journey among the included journeys, using a screenshot from a user interface of an example embodiment for creating software.

Upon selecting one of the INCLUDED JOURNEYS, the user interface shows an expanded view of the features with a page that may be presented to a customer. In some embodiments, the page may be a simplified version different from what the customer ultimately sees.

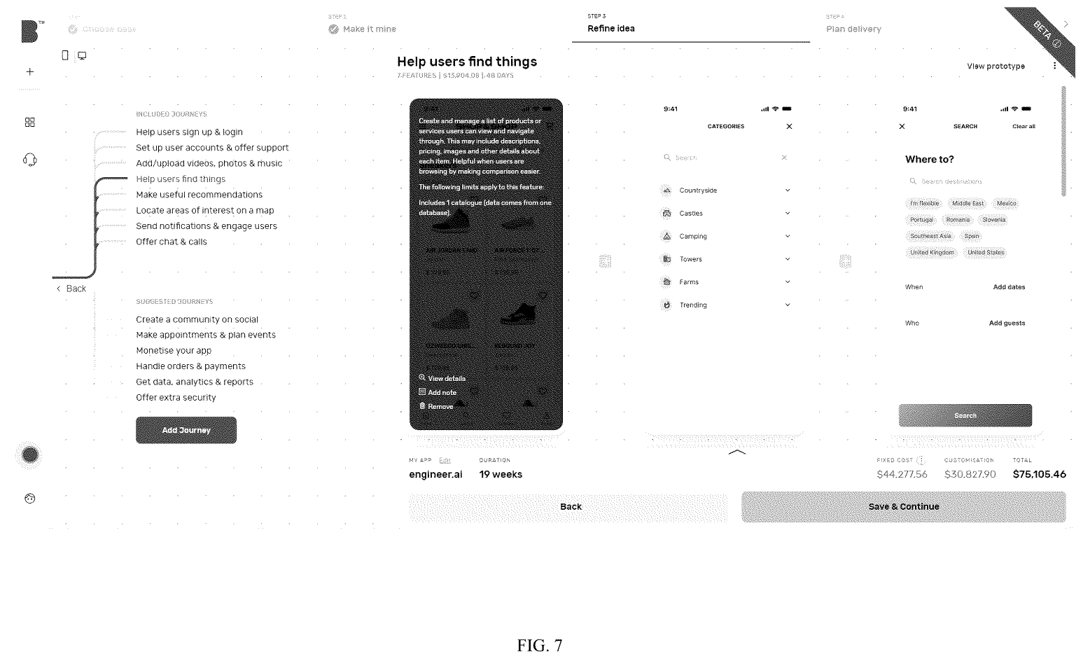

FIG. 7 describes and illustrates a user experience in hovering over the features of FIG. 6 to review detailed description, using a screenshot from a user interface of an example embodiment for creating software.

Upon interacting with (e.g., hovering over) the feature cards, a user may view detailed descriptions of each feature, including relevant information, functions, and any limitations. A user may remove a feature deemed unnecessary and can add notes regarding the feature. A user may also click a portion of the feature card to view additional details.

When a user hovers over or clicks a feature for a more detailed description, the LLM can automatically generate plain-language explanations or even compare two features.

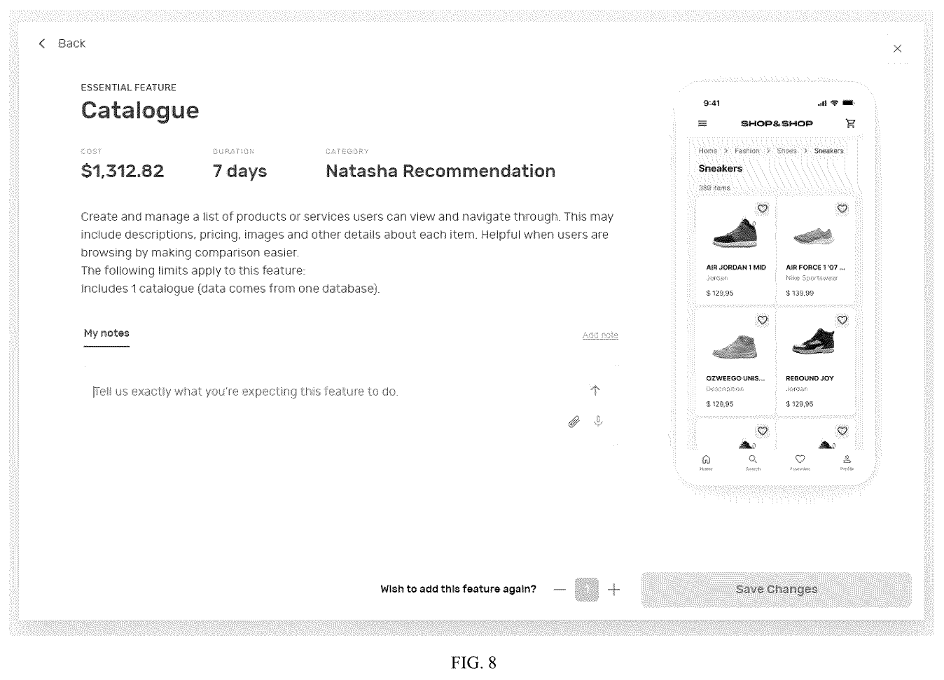

FIG. 8 describes and illustrates a user experience in clicking the features of FIG. 6 to review further details, using a screenshot from a user interface of an example embodiment for creating software.

Upon clicking a feature card, the user may see more extensive details such as individual cost, individual duration, a category (e.g., essential or recommended), and other relevant information. A user may may add notes about the feature, and add that feature to the custom software application, or remove it.

In some embodiments, essential features are necessary for maintaining a journey. Recommended features may not be necessary to keep a journey. If a user chooses to remove an essential feature, the platform may prompt a message that the associated journey must be deleted.

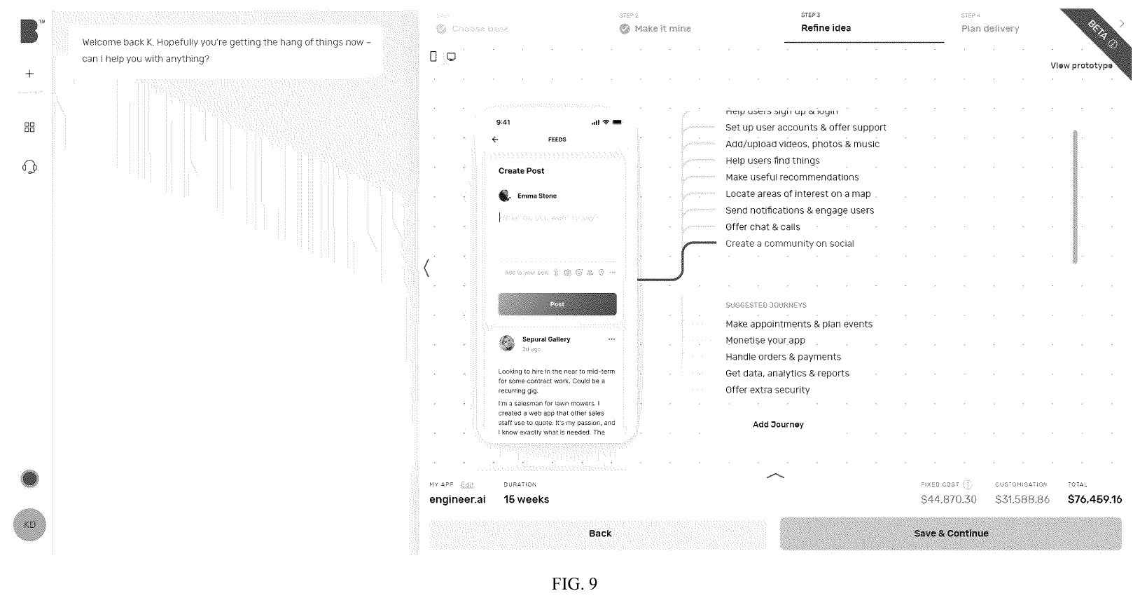

FIG. 9 describes and illustrates a user experience in adding a suggested journey to the included journeys, using a screenshot from a user interface of an example embodiment for creating software.

For example, upon adding a journey named ‘Create a community on social’ from the list of SUGGESTED JOURNEYS, the journey may be real-time added to INCLUDED JOURNEYS. This addition also changes total duration and cost to make the custom software application.

In some embodiments, the LLM can proactively suggest additional journeys based on user-entered project goals or descriptions, for example, by analyzing journey metadata stored in databases.

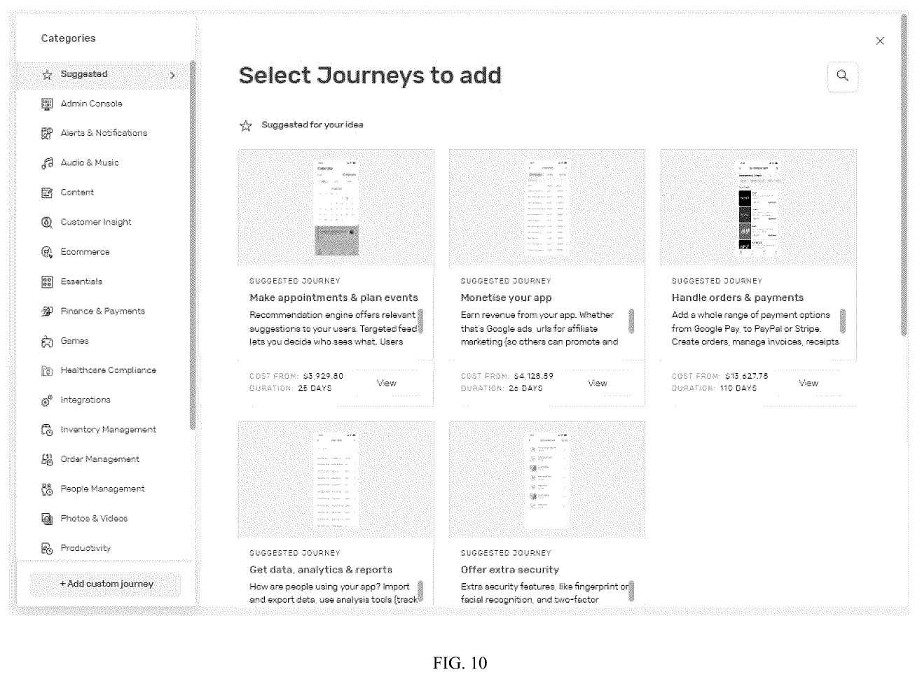

FIG. 10 describes and illustrates a user experience in exploring more journeys to be added to the included journeys, using a screenshot from a user interface of an example embodiment for creating software.

Upon clicking ‘Add journey’, a user may be able to explore entire journeys/features in a card format. Each journey/feature card may include information about individualized cost/duration and graphical information. A user may be able to review additional information about each journey/feature card by interacting with it.

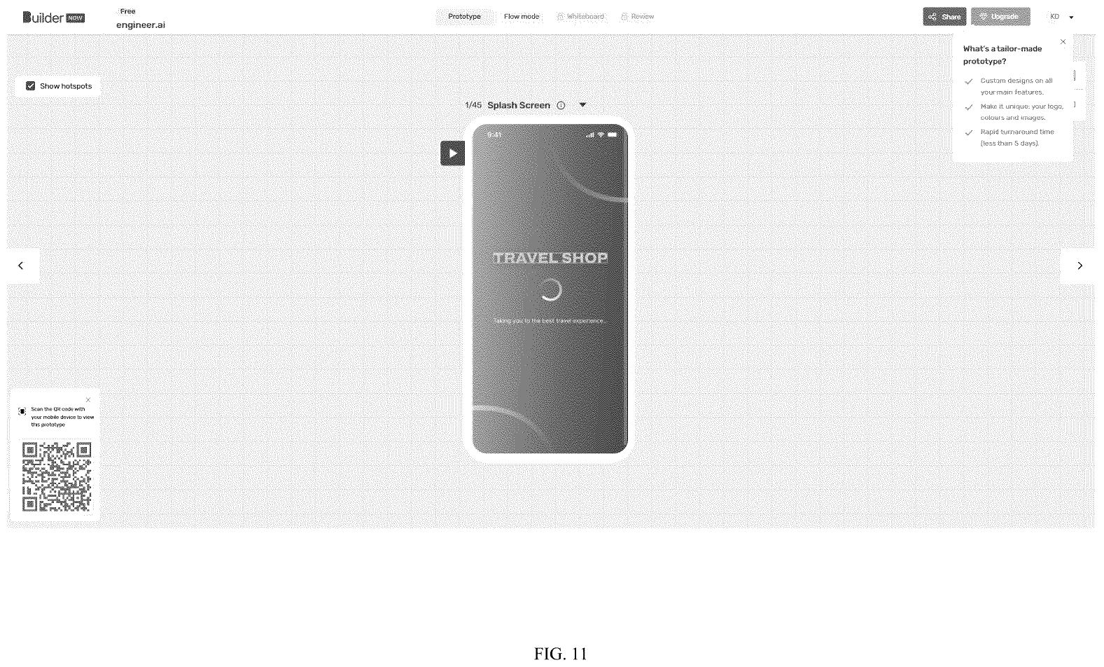

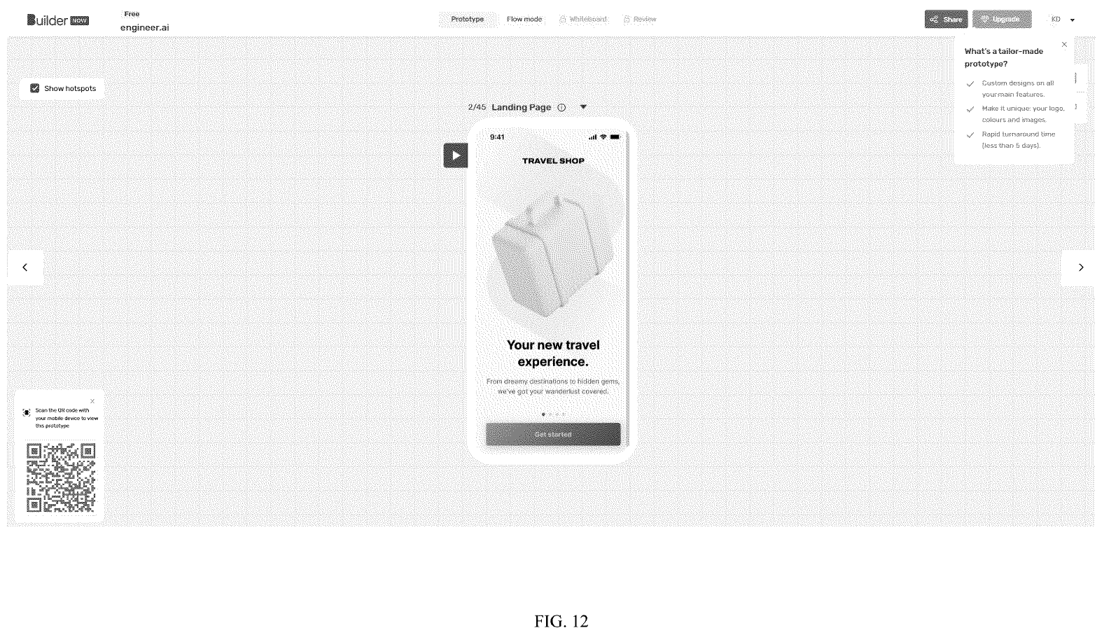

FIGS. 11-12 describe and illustrate a user experience in exploring a prototype with the selected features, using a screenshot from a user interface of an example embodiment for creating software.

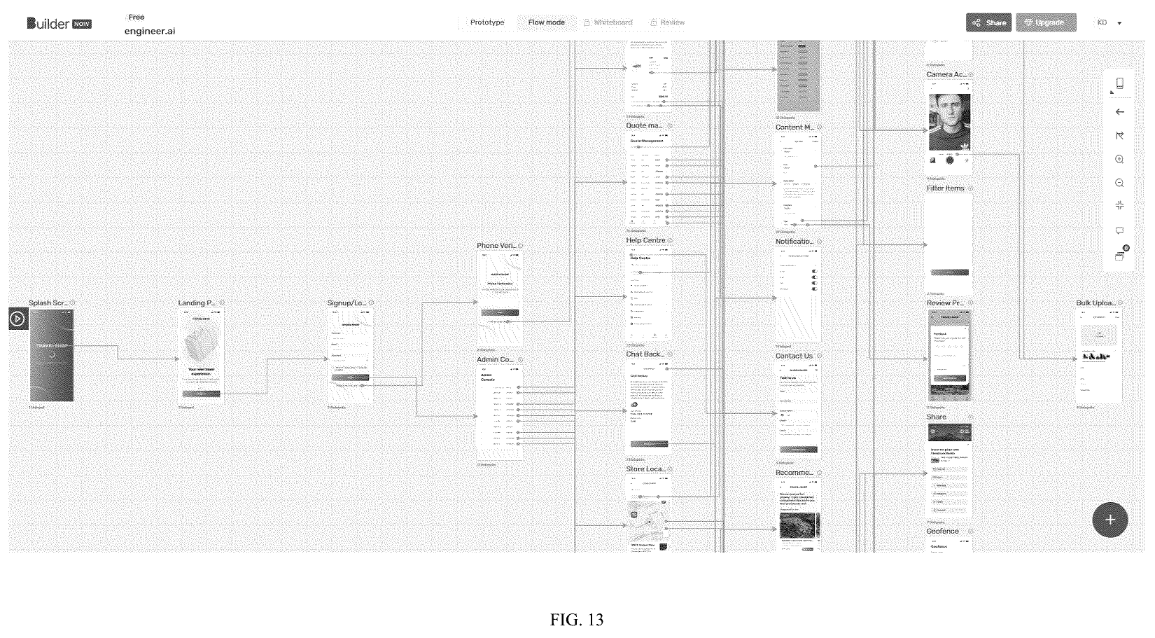

FIG. 13 describes and illustrates a user experience in exploring the selected features in a flow mode, using a screenshot from a user interface of an example embodiment for creating software.

In the flow mode, a user may review the connection of each feature with other features in an expanded view. This helps ensure that the selected features collectively support the desired functionality.

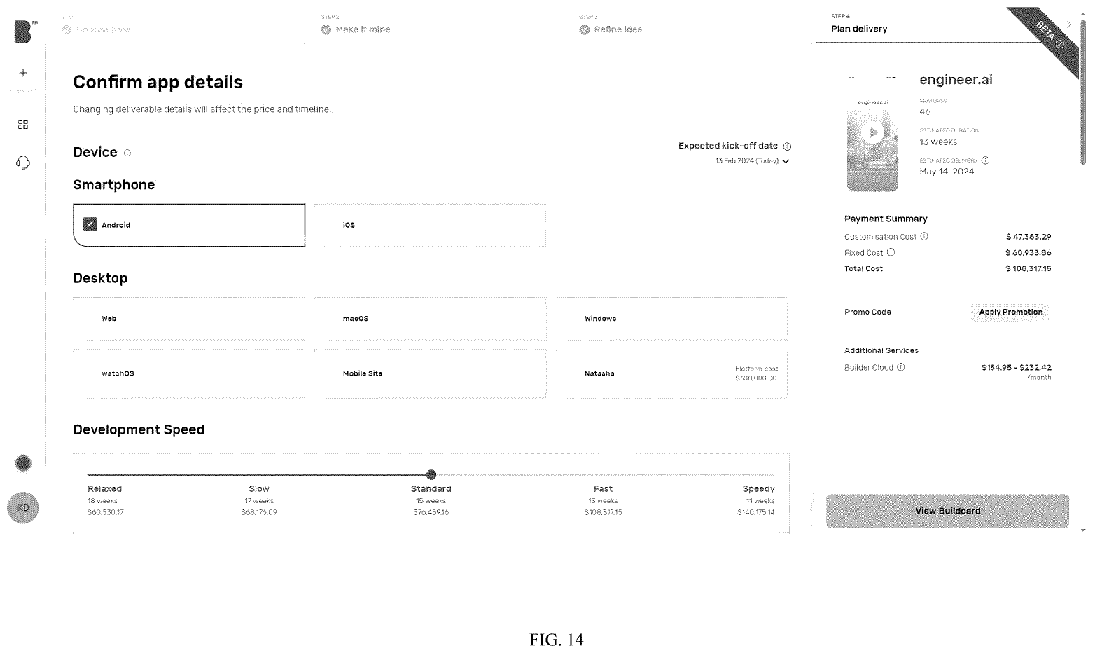

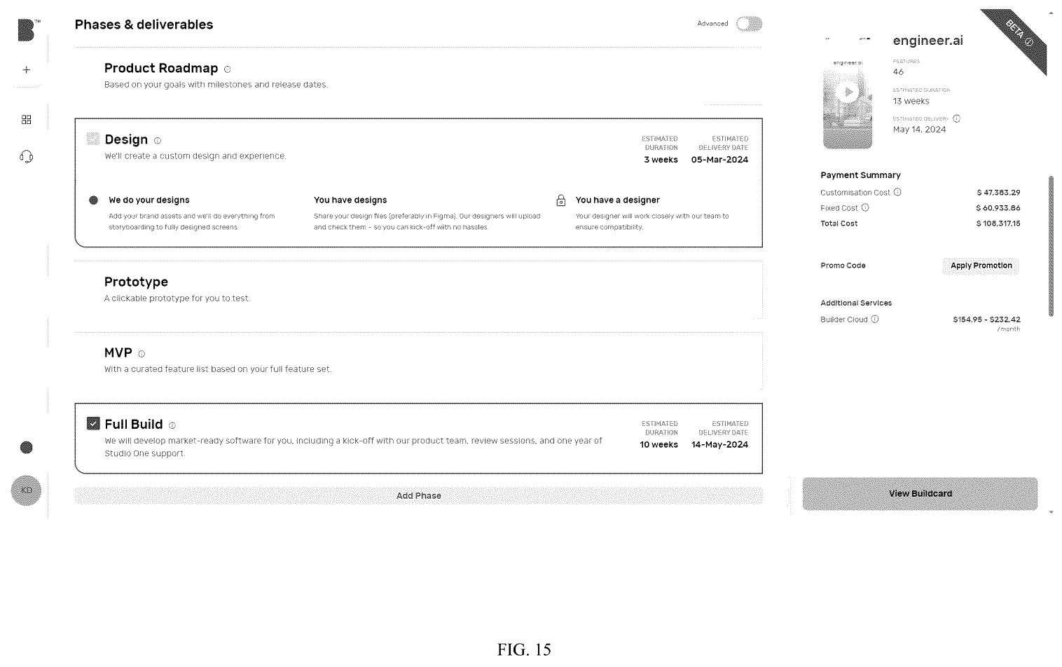

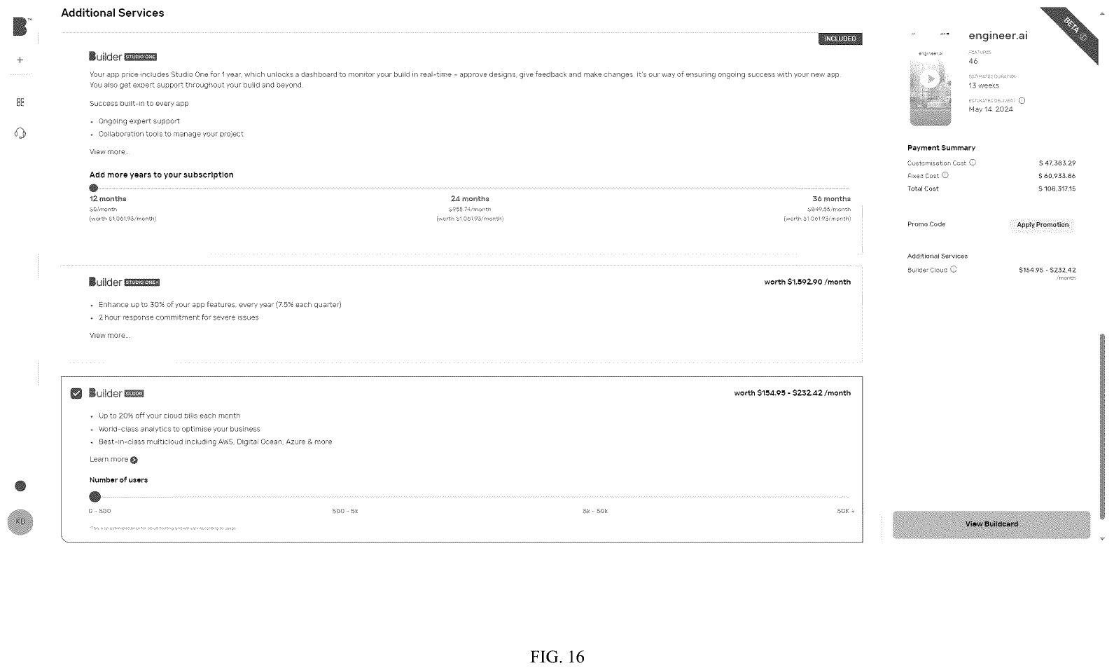

FIGS. 14-16 describe and illustrate a user experience in reviewing and choosing details of the custom software application, using a screenshot from a user interface of an example embodiment for creating software.

A user in the final stage may be able to see a build card that includes information about platforms, devices, development speed, phases & deliverables (e.g., product roadmap, design, prototype, MVP, full build, etc.). A user can also choose additional services (e.g., monthly/yearly subscriptions for support, enhancement, discount, etc.) provided by the platform company.

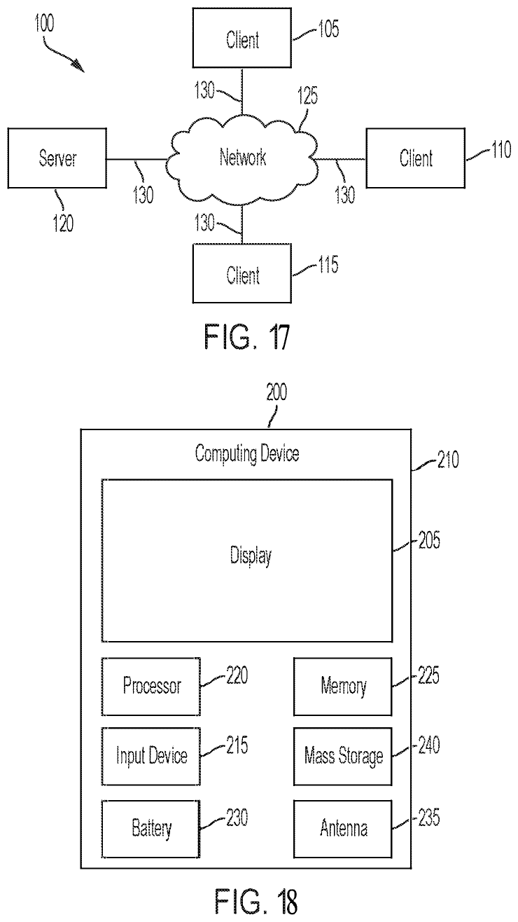

Referring to FIG. 17, system 100 is merely illustrative of an embodiment and does not limit the scope of the systems and methods described in the present disclosure. One of ordinary skill in the art would recognize other variations, modifications, and alternatives. For example, more than one server system (120) may be connected to a communication network (125). As another example, multiple client devices (105, 110, and 115) may be coupled to communication network (125) via an access provider (not shown) or another server system. A server system (120) and a client device (105) may be part of the same or different hardware systems. A server system (120) may be operated by an entity different from the one operating an embodiment of the software development platform described herein, or by the same entity.

Client devices (105, 110, 115) typically request information from server system (120), which processes and returns the requested data. Server systems generally have more computing and storage capacity than client devices, but a particular computer can function as both a client and a server depending on whether it is requesting or providing data. Aspects of the disclosed platform can be implemented in a client-server or cloud-cloud environment.

Server (120) receives information requests from client devices (105, 110, 115), performs processing to satisfy the requests, and forwards results back to the requesting client device. The processing may be performed locally on server (120) or delegated to other servers on network (125).

Client devices (105, 110, 115) enable users to access and query information or applications stored by server (120). Examples of client devices include portable electronic devices (e.g., smartphones running Apple iOS™, Android™, or Windows Mobile®), laptops, desktops, and tablets. In some embodiments, a web browser or an application on a client device allows users to select, access, retrieve, or query data hosted by server (120).

FIG. 18 depicts an example of a computing device (200) usable as a client device in certain embodiments. The computing device (200) includes a display (205), a housing (210), and an input device (215). Within housing (210), familiar components reside, such as a processor (220), memory (225), battery (230), transceiver and antenna (235), mass storage (240), audio (e.g., speaker, microphone), I/O controllers, network interfaces, and so forth. A bus or another communication mechanism may connect these internal components. Memory (225) stores data and instructions to be executed by processor (220), and mass storage (240) may hold system software, user applications, or other persistent data.

Input device (215) may include a touchscreen, keyboard, buttons, switches, stylus, gestures, or biometric sensors. Mass storage (240) could be flash memory, solid-state drives, magnetic disks, optical disks, or other storage media.

System (100) may also operate with different hardware configurations, such as multiple processors for parallel operations or additional caching mechanisms. The computing device (200) shown in FIG. 18 is one illustration among many possible configurations. In some embodiments, it is a smartphone or tablet (e.g., Apple iPhone®, Samsung Galaxy®, or iPad®), while in others it may be a laptop, netbook, or desktop computer.

A computer-implemented version of instructions usable with the present disclosure may be embodied, for example, on a computer-readable medium (e.g., flash memory, optical or magnetic disk). The instructions, when executed by a processor, configure a computer system to implement various features or processes described herein. Examples of operating systems include iOS®, Android™, Windows®, Linux®, and many others.

The disclosed system may connect to a network that can be an intranet, the Internet, or another form of wired or wireless network. For instance, data may be transmitted at least partially via Wi-Fi (IEEE 802.11 standards) or cellular protocols.

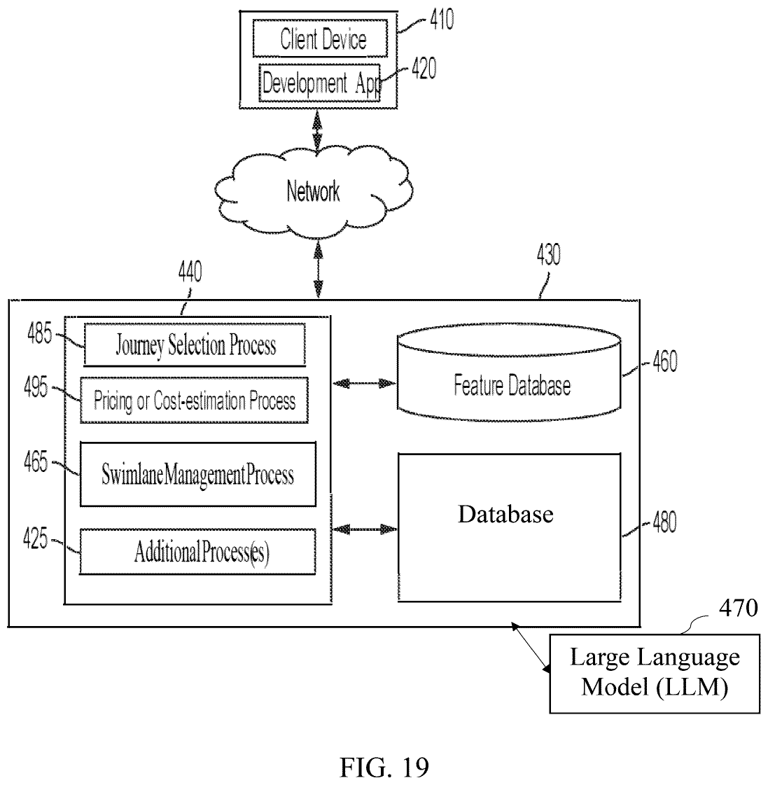

FIG. 19 illustrates a system for developing software in accordance with an embodiment of the present disclosure. In this example, an application development software application (420) runs on an electronic device (410), and a builder software application (440) operates on one or more servers (430). The electronic device (410) can be a desktop computer, laptop, tablet, or mobile phone communicating with the server over a wireless or wired network. Both the electronic device and the server(s) are computer systems having processors, memory, and network interfaces.

Within the builder application (440), several processes may be present. For example, journey selection process (485) can allow customers to select, add, or remove journeys and features for their custom software application; pricing process (495) can dynamically calculate or update costs based on these selections; and swimlane management process (465) can handle the distribution of features across parallel swimlanes, including splitting or merging swimlanes if a threshold is exceeded. Additional processes (425), such as prototyping or developer assignment, may also be included. The builder application (440) maintains a library of features in database (460) and can send these features to the development application (420) running on client device (410). In response, it can receive the user's specific feature selections and generate an integrated build card that reflects journeys, features, cost, and scheduling details. In some embodiments, builder application (440) also maintains a database (480), which stores relationships among features, journeys, and other entities for advanced data analytics or recommendation algorithms.

The software development application (420) provides a graphical user interface enabling a user to select and customize a set of features and journeys that together form the build card for constructing the user's custom software application. In certain embodiments, the software development application (420) is a web application running in a conventional browser on the client device (410). In other embodiments, it is a dedicated client application that communicates with server (430) to display the available features, apply updates from the builder application (440), and render real-time changes to the build card-including price recalculations from pricing process (495) or updated swimlane distributions from swimlane management process (465). In real-time, the LLM (470) can also explain to the user why certain changes inflate cost or extend the development timeline by, for example, generating a short natural-language summary.

In some embodiments, the system integrates a large language model (LLM) (470) that interfaces with the builder application (440) and databases (460, 480). The LLM (470) can interpret and refine user requests (e.g., in natural language) for journey and feature selection, generate recommendations on optimal combinations of features, and predict potential development challenges or cost variations. The LLM (470) may leverage the relationships stored in database (480) to provide context-driven insights—for example, identifying feature dependencies or suggesting alternative swimlane distributions. The LLM (470) can be configured as part of the platform or builder application or it can be an external resource. For instance, the LLM (470) could be a publicly available service, such as GPT or Google Gemini, that is not under the same computer domain as the builder platform, or a hybrid arrangement could be used. Communications with the LLM can be through electronic messages, e.g., as described herein. This real-time guidance enhances the builder application's functionality by reducing manual analysis and expediting the creation of accurate, cost-efficient build cards.

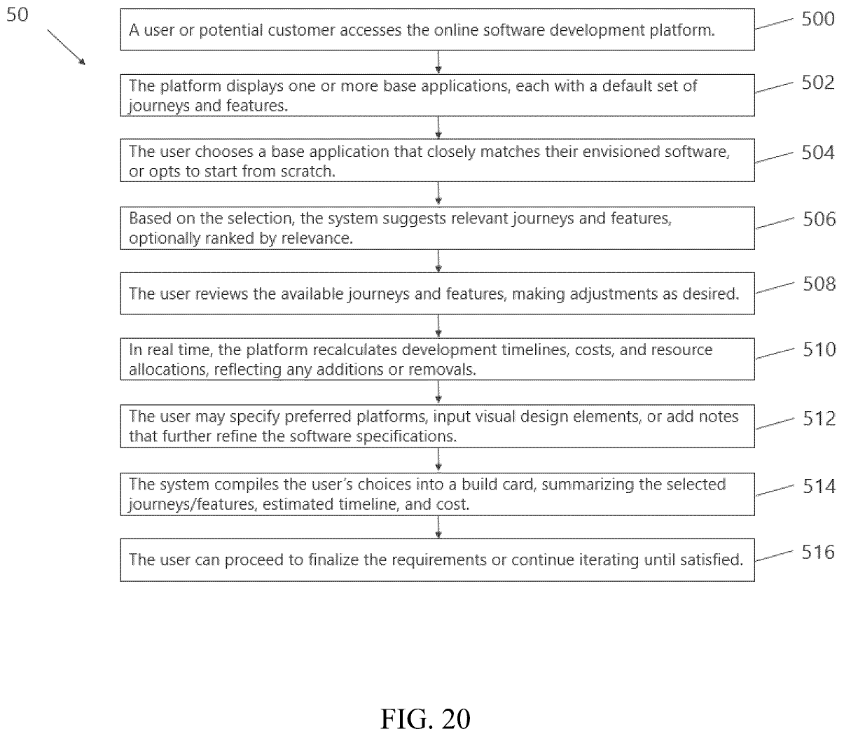

Referring to FIG. 20, a flowchart 50 depicts an example user-driven configuration process for building a custom software application. In step 500, a user or potential customer accesses the online software development platform. In step 502, the platform displays one or more base applications, each with a default set of journeys and features. At step 504, the user either selects a base application closely matching their envisioned software or opts to start from scratch. Based on this selection, the system suggests relevant journeys and features at step 506, optionally ranking them by relevance.

In step 508, the user reviews the journeys and features, adding or removing them as needed. The platform then recalculates relevant timelines, costs, and resource allocations in real time at step 510. Step 512 allows the user to specify additional options such as preferred platforms, visual design elements, or notes clarifying the software's requirements. Finally, the system compiles these selections into a build card (step 514), summarizing the chosen journeys, features, and estimated timelines. At step 516, the user can finalize the requirements or continue iterating until satisfied.

Illustrative software development systems are described in U.S. Pat. No. 10,649,741, issued May 12, 2020, which is incorporated by reference herein in its entirety. Also, the following example of an application implementing swimlanes is incorporated herein in its entirety U.S. patent application Ser. No. 18/295,842, filed Apr. 5, 2023.

Each system, server, computing device, and computer described herein can be implemented on one or more computer systems and be configured to communicate over a network. In one embodiment, the computer system includes a bus or other communication mechanism for communicating information, and a hardware processor coupled with bus for processing information.

The computer system also includes a main memory, such as a random access memory (RAM) or other dynamic storage device, coupled to bus for storing information and instructions to be executed by a processor of the computer or computing device. Main memory also may be used for storing temporary variables or other intermediate information during execution of instructions to be executed by a processor. Such instructions, when stored in non-transitory storage media accessible to processor, configure the computer system into a special-purpose machine that is customized to perform the operations specified in the instructions and provide or be capable of features and functionality described herein. The processes described herein can be implemented as computer instructions executable by the processor of a computer or computing device to perform described process steps. The computer instructions can be saved on nonvolatile or nontransitory memory for providing such implementations.

The computer system further includes a read only memory (ROM) or other static storage device coupled to bus for storing static information and instructions for processor. A storage device, such as a magnetic disk or optical disk, is provided and coupled to bus for storing information and instructions.

The computer system may be coupled via bus to a display, such as an LCD, for displaying information to a computer user. An input device, including alphanumeric and other keys, may be coupled to bus for communicating information and command selections to processor. Another type of user input device is cursor control, such as a mouse, a trackball, touchscreen (e.g., on mobile phones) or cursor direction keys for communicating direction information and command selections to processor and for controlling cursor movement on display. This input device typically has two degrees of freedom in two axes, a first axis (e.g., x) and a second axis (e.g., y), that allows the device to specify positions in a plane.

The computer system may implement the techniques described herein using customized hard-wired logic, one or more ASICs or FPGAs, firmware and/or program logic which, in combination with the computer system, causes or programs the computer system to provide specialized features. According to one embodiment, the techniques herein are performed by the computer system in response to the processor executing one or more sequences of one or more instructions contained in main memory. Such instructions may be read into main memory from another storage medium, such as a storage device. Execution of the sequences of instructions contained in main memory causes the processor to perform the process steps described herein. In alternative embodiments, hard-wired circuitry may be used in place of or in combination with software instructions.

The term storage media as used herein refers to any non-transitory media that stores data and/or instructions that cause a machine to operate in a specific fashion. Such storage media may comprise non-volatile media and/or volatile media. Non-volatile media includes, for example, optical or magnetic disks, such as storage device. Volatile media includes dynamic memory, such as main memory. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus. Transmission media can also take the form of acoustic or light waves, such as those generated during radio-wave and infra-red data communications.

Various forms of media may be involved in carrying one or more sequences of one or more instructions to the processor for execution. For example, the instructions may initially be carried on a magnetic disk or solid-state drive of a remote computer. A bus carries the data to the main memory, from which the processor retrieves and executes the instructions. The instructions received by the main memory may optionally be stored on a storage device either before or after execution by the processor.

The computer system also includes a communication interface coupled to bus. The communication interface provides a two-way data communication coupling to a network link that is connected to a local network. For example, the communication interface may be an integrated services digital network (ISDN) card, cable modem, satellite modem, or a modem to provide a data communication connection to a corresponding type of telephone line. As another example, the communication interface may be a local area network (LAN) card to provide a data communication connection to a compatible LAN. Wireless links may also be implemented. In any such implementation, the communication interface sends and receives electrical, electromagnetic or optical signals that carry digital data streams representing various types of information.

Network link typically provides data communication through one or more networks to other data devices. For instance, network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on the network link and through the communication interface, which carry the digital data to and from the computer system, are example forms of transmission media.

The computer system can send messages and receive data, including program code, through the network(s), network link and the communication interface. In the Internet example, a server might transmit a requested code for an application program through Internet, ISP, local network and the communication interface.

The received code may be executed by the processor as it is received, and/or stored in storage device, or other non-volatile storage for later execution.

It should be understood that variations, clarifications, or modifications are contemplated. Applications of the technology to other fields are also contemplated.

Exemplary systems, devices, components, and methods are described for illustrative purposes. Further, since numerous modifications and changes will readily be apparent to those having ordinary skill in the art, it is not desired to limit the disclosure to the exact constructions as demonstrated in this disclosure. Accordingly, all suitable modifications and equivalents may be resorted to falling within the scope of the disclosure.

Thus, for example, any sequence(s) and/or temporal order of steps of various processes or methods that are described herein are illustrative and should not be interpreted as being restrictive. Accordingly, it should be understood that although steps of various processes or methods or connections or sequence of operations may be shown and described as being in a sequence or temporal order, they are not necessarily limited to being carried out in any particular sequence or order. For example, the steps in such processes or methods generally may be carried out in various different sequences and orders, while still falling within the scope of the present disclosure. Moreover, in some discussions, it would be evident to those of ordinary skill in the art that a subsequent action, process, or feature is in response to an earlier action, process, or feature.

It is also implicit and understood that the applications or systems illustratively described herein provide computer-implemented functionality that automatically performs a process or process steps unless the description explicitly describes user intervention or manual operation.

It is understood from the above description that the functionality and features of the systems, devices, components, or methods of embodiments of the present disclosure include generating and sending signals to accomplish the actions.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present disclosure.

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that, for example, may involve multiple possibilities, but to a person of ordinary skill in the art, a reasonable or primary understanding or meaning is understood.

It should be understood that the above-described examples are merely illustrative of some of the many specific examples that represent the principles described herein. Clearly, those skilled in the art can readily devise numerous other arrangements without departing from the scope of the present disclosure.

What is claimed is:

1. An online software development system for developing software applications, comprising:
a computer configured to:
determine one or more journeys for a user's custom software application based on a selection of a base application or other user inputs;
determine a set of swimlanes, each swimlane being a parallel workstream, to define a development timeline for the custom software application based on the journeys and features;
enable the user to modify at least one of the journeys or the features;
adjust the set of swimlanes in response to the modification; and
display to the user, in real time, updated pricing information or an updated development timeline based on the journeys and the features.

2. The system of claim 1, wherein the computer is further configured to:
maintain a threshold number of features allowable in each swimlane, and
automatically split a journey into multiple swimlanes when adding a new feature would exceed the threshold number.

3. The system of claim 1, wherein the computer is further configured to:
remove a swimlane or merge it with another swimlane in response to the user removing at least one feature from a journey such that the swimlane's feature count no longer meets a threshold number, and
recalculate the development timeline accordingly.

4. The system of claim 1, wherein the computer is further configured to apply one or more machine learning algorithms to distribute features among the swimlanes in a manner that minimizes an estimated total duration for completing the features.

5. The system of claim 1, wherein the computer is further configured to:
generate a build card comprising the journeys, the swimlanes, pricing details, and the development timeline; and
display the build card to the user, enabling further real-time edits to the journeys or features.

6. The system of claim 1, wherein the computer is further configured to automatically categorize each feature as either essential or recommended, and to prompt the user with a requirement to delete or alter a journey when the user attempts to remove an essential feature.

7. The system of claim 1, wherein the computer is further configured to provide a user interface that enables the user to select at least one operating system or platform for building the custom software application, and to update the development timeline or pricing based on the selected operating system(s) or platform(s).

8. The system of claim 1, wherein the computer is further configured to accept real-time feedback or annotations from the user on any journey or feature, and to recalculate any associated cost or duration based on the user's feedback.

9. The system of claim 1, wherein the computer is further configured to access a code repository storing source code for previously used features, automatically retrieve and assemble the appropriate modules for the user's selections and indicate any newly created or updated source code segments needed to complete the build.

10. The system of claim 1, wherein the computer is further configured to estimate resource allocation for balancing feature development across swimlanes and minimizing the total cost of completing the custom software application.
